(19) United States
(12) Patent Application Publication
(10) Pub. No.: US 2013/0025740 A1
(43) Pub. Date: Jan. 31, 2013

(54) CONTAINER FOR DISPENSING LIQUID

(71) Applicant: Ruby Osten, Toronto (CA)

(72) Inventor: Ruby Osten, Toronto (CA)

(21) Appl. No.: 13/560,249

(22) Filed: Jul. 27, 2012

Related U.S. Application Data
(60) Provisional application No. 61/512,766, filed on Jul. 28, 2011.

(51) Int. Cl. B65D 51/04; B65B 3/04; B23P 19/04; B65D 51/18

(52) U.S. Cl. 141/1; 220/810; 220/254.2; 220/254.3; 29/428

(57) ABSTRACT

A container for dispensing liquid, methods for making the container, and methods for dispensing liquid using the container. The container comprises a first end, a second end, and siding defining a hollow container body, wherein the siding is sealingly connected to the first end and second end for containing the liquid within the container. The container further comprises a primary dispenser, a secondary dispenser, and in some example embodiments additional dispensers.

### FIELD

The described embodiments relate to containers for dispensing liquids such as shampoo, conditioner, gel, paste, cream, lotion, cosmetics, cleanser, liquid soap, and so on.

### BACKGROUND

Conventional containers may make it difficult to empty the liquid product contained therein which results in wasted liquid product. In addition, a conventional container may only have a single dispenser of one specific shape or location. There exists a need for an improved container for dispensing liquid, methods for dispensing liquid in a container, and methods of making a container for dispensing liquids, or at least alternatives.

### SUMMARY

In a first aspect, some embodiments described herein provide a container for dispensing liquid comprising:
a first end;
a second end;
siding defining a hollow container body, wherein the siding is sealingly connected to the first end and second end for containing the liquid within the container;
a primary dispenser for dispensing the liquid from the container;
a secondary dispenser having a closed position for sealing the liquid within the container and an open position for dispensing the liquid from the container, wherein the secondary dispenser is defined by a portion of the first end and a portion of siding adjacent to the first end, wherein the secondary dispenser comprises a hinge and an opening mechanism, wherein the hinge is located on one of the first end and the siding adjacent to the first end and wherein the opening mechanism is located on the other of the first end and the siding adjacent to the first end.

In accordance with some embodiments, the primary dispenser is located on the first end.

In accordance with some embodiments, the primary dispenser is located on the first end and the secondary dispenser extends from a position on the first end on one side of the primary dispenser to a portion of siding adjacent to the first end on the other side of the primary dispenser such that the secondary dispenser encloses or surrounds the primary dispenser.

In accordance with some embodiments, the secondary dispenser and the primary dispenser are on the same end and the secondary dispenser extends from a position on one side of the primary dispenser to a position on the same side of the primary dispenser such that the secondary dispenser is situated to the one side of the primary dispenser.

In accordance with some embodiments, the second end is adapted to support the container on a horizontal surface.

In accordance with some embodiments, the first end is adapted to support the container on a horizontal surface.

In accordance with some embodiments, the primary dispenser is located on the second end.

In accordance with some embodiments, the opening mechanism enables the secondary dispenser to move between the open position and the closed position. In accordance with some embodiments, the opening mechanism is resealable. The opening mechanism may be a resealable clasp mechanism, a pull tab mechanism, a thumb notch mechanism, and so on. In accordance with some embodiments, the opening mechanism may be initially tamper proof.

In accordance with some embodiments, the container comprises a tertiary dispenser for dispensing the liquid from the container, wherein the tertiary dispenser is formed by a portion of an end and a portion of siding adjacent to the end, wherein the tertiary dispenser comprises a hinge and an opening mechanism, wherein the hinge is located on one of the ends and the siding and wherein the opening mechanism is located on the other of the ends and the adjacent siding. The primary and secondary dispenser may be on the same or different ends.

In accordance with some embodiments, the hinge is an integral hinge.

In accordance with some embodiments, the primary dispenser comprises an opening on the second end, a cap configured to sealingly connect to the opening and an applicator wand connected to the cap and shaped to be inserted within the hollow container body.

In accordance with some embodiments, at least one of the first end and the second end are shaped to support the container on a surface.

In another aspect, some embodiments described herein provide a method of dispensing liquid in a container comprising the steps:
holding a container, wherein the container comprises:
   a first end;
   a second end;
   siding defining a hollow container body, wherein the siding is sealingly connected to the first end and second end for containing the liquid within the container;
   a primary dispenser for dispensing the liquid from the container;
   a secondary dispenser having an open position for dispensing the liquid from the container and a closed position for sealing the fluid within the container, wherein the secondary dispenser is defined by a portion of the first end and a portion of siding adjacent to the first end, wherein the secondary dispenser comprises a hinge and an opening mechanism, wherein the hinge is located on one of the first end and the siding adjacent to the first end and wherein the opening mechanism is located on the other of the first end and the adjacent siding.
using the primary dispenser to dispense the fluid from the container; and
using the secondary dispenser to dispense the fluid from the container.

In another aspect, some embodiments described herein provide a method of providing liquid in a container having an opening comprising the steps:
providing liquid in the opening of the container, wherein the container comprises: a first end; a second end; siding defining a hollow container body, wherein the siding is sealingly connected to the first end and second end for containing the liquid within the container; a primary dispenser for dispensing the liquid from the container; a secondary dispenser having an open position for dispensing the liquid from the container and a closed position for sealing the liquid within the container, wherein the secondary dispenser is defined by a portion of the first end and a portion of siding adjacent to the first end, wherein the secondary dispenser comprises a hinge and an opening mechanism, wherein the hinge is located on one of the first end and the siding adjacent to the first end and wherein the opening mechanism is located on the other of the first end and the adjacent siding; and
sealing the opening of the container.

In a further aspect, some embodiments described herein provide a method of making a container for dispensing liquids comprising the steps:
molding a container comprising a first end, a second end, and siding defining a hollow container body such that the siding is sealingly connected to the first end and second end for containing the liquid within the container;
defining a primary dispenser for dispensing the liquid from the container;
defining a secondary dispenser having an open position for dispensing the liquid from the container and a closed position for sealing the liquid within the container, wherein the secondary dispenser is defined by a portion of the first end and a portion of siding adjacent to the first end;
providing a hinge and an opening mechanism for the secondary dispenser, wherein the hinge is located on one of the first end and the siding adjacent to the first end and wherein the opening mechanism is located on the other of the first end and the siding adjacent to the first end.

In accordance with some embodiments, the method may further comprise:
filling the container with liquid; and
sealing the container.

### BRIEF DESCRIPTION OF THE DRAWINGS

Example embodiments will now be described in detail with reference to the drawings, in which:

FIG. 1 illustrates perspective views of a container for dispensing liquid in accordance with embodiments described herein;

FIG. 2 illustrates perspective views of a container for dispensing liquid in accordance with other embodiments described herein;

FIG. 3 illustrates perspective views of a container for dispensing liquid in accordance with other embodiments described herein;

FIG. 4 illustrates perspective views of a container for dispensing liquid in accordance with other embodiments described herein;

FIG. 5 illustrates perspective views of a container for dispensing liquid in accordance with other embodiments described herein;

FIG. 6 illustrates perspective views of an alternative configuration of the container of FIG. 5 in accordance with other embodiments described herein;

FIG. 7 illustrates perspective views of a container for dispensing liquid in accordance with other embodiments described herein;

FIG. 8 illustrates perspective views of the container of FIG. 7;

FIG. 9 illustrates a flow chart diagram of a method dispensing liquid in a container in accordance with other embodiments described herein; and

FIG. 10 illustrates a flow chart diagram of a method of making a container for dispensing liquids in accordance with other embodiments described herein.

### DESCRIPTION OF EXEMPLARY EMBODIMENTS

Various containers and methods will be described below as example embodiments. The described example embodiments should not limit the claims. It is possible that containers or methods described below may not be an example embodiment of any claim. The figures and description describe example embodiments and there may be variations of container type, container shape, dispenser type and position in different example embodiments.

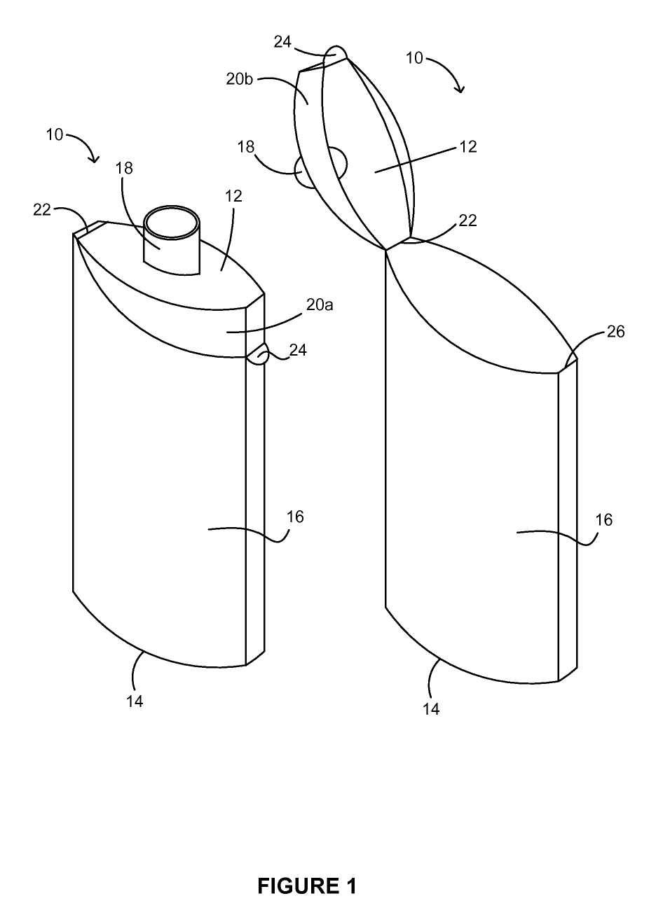

Referring now to FIG. 1, which illustrates perspective views of a container 10 for dispensing liquid in accordance with embodiments described herein. The liquid may be any type of liquid that may be stored in a container such as shampoo, conditioner, gel, paste, cream, lotion, cosmetics, shaving gel, gloss, syrup, mouse, personal care product, cleanser, liquid soap, motor oil, detergents, cleaning products, consumer product, industrial product, automobile fluid, food product, sauce, drink, condiment, and so on. The container 10 may be of various shapes and container types. In accordance with embodiments described herein, the container 10 may be manufactured with one or more dispensers. The container 10 may then be provided to a liquid manufacturer, distributer or provider without the liquid therein, so that it may be subsequently filled with any liquid through an opening in the container 10, and sealed. Accordingly, the container 10 may be sold with or without liquid therein.

The container 10 for dispensing liquid has a first end 12, a second end 14, and siding 16 defining a hollow container body. In this example, the siding 16 extends around the perimeter of the first end 12 and second end 14 and is sealingly connected to the first end 12 and second end 14 in order to contain liquid when it is inserted into the container 10. In another example, the container 10 may be a tube, such as a toothpaste tube, where one end 12 may be circular or square, the siding 16 may extend from the end in a conical, triangular or prism shape to another end 14 which closes or seals the tube.

The container 10 has a primary dispenser 18 for dispensing the liquid from the container 10. In this example embodiment, the primary dispenser 18 is located in approximately the middle of the first end 12.

The container 10 has a secondary dispenser 20 for dispensing the liquid from the container 10. The secondary dispenser 20 may be used when the container is almost empty of liquid when it is difficult to dispense the liquid using the primary dispenser 18. The secondary dispenser 20 may also have a different shape and be in a different location than the primary dispenser 18 to provide an alternative way to access the liquid in the container, such as for example using an instrument that cannot fit into the primary dispenser 18. For example, the secondary dispenser 20 may be larger than the primary dispenser 18 to facilitate access to the liquid. This may especially be the case when there is only a small amount of liquid left in the container 10. In addition, the primary dispenser 18 and the secondary dispenser 20 may have different shapes to provide alternative ways to access the liquid. In this example embodiment, the primary dispenser 18 may be smaller in size with a more directed opening making it easier to access small amounts of the liquid within the container 10, especially when there is still a substantial amount of liquid left in the container 10. However, as the liquid empties with use it may be desirable to access the remaining amount of liquid that has collected on the first end 12 due to gravity using the secondary dispenser 20. In addition, the larger and different size of the secondary dispenser 20 may provide alternative options to access the liquid such as by using an instrument or hand, for example. In other embodiments, the secondary dispenser 20 may be smaller in size and have a different shape.

The secondary dispenser 20 has a closed position 20a for sealing the liquid within the container 10 and an open position 20b for dispensing the liquid from the container 10. The secondary dispenser 20 provides a liquid tight seal when in the closed position 20a. The secondary dispenser 20 may initially provide a tamper proof seal. The secondary dispenser 20 may be defined by a portion of the first end 12 and a portion of siding adjacent to the first end 16. As shown, in this example the secondary dispenser 20 is defined by a large part of the first end 12 and the top portion of the siding 16 that abuts the first end 12. However, the secondary dispenser 20 may be defined by a smaller or larger portion of the first end 12 and siding 16 in alternative embodiments. For example, the secondary dispenser 20 may be defined by a small part of the first end 12 and a large portion of the siding 16 that abuts the first end 12.

The secondary dispenser 20 comprises a hinge 22 and an opening mechanism 24. The opening mechanism 24 may be used to change the secondary dispenser 20 from the closed position 20a to the open position 20b, and vice versa. In this example embodiment, the hinge 22 is located on the first end and the opening mechanism 24 is located on siding 16 adjacent to the first end 16. The hinge 22 may be an integral hinge or living hinge, and the opening mechanism 24 may be a clasp that sealingly locks onto the siding 16 by an integral bead 26 formed in the siding 16. In this example embodiment, the opening mechanism 24 may be a clasp and bead that can reseal the secondary dispenser 20 for multiple movements from the closed position 20a to the open position 20b and from the open position 20b to the closed position 20a. Other types of hinges and opening mechanisms may also be used. The opening mechanism 24 may provide for a liquid tight seal so that the liquid in the container does not leak out when the container 10 is in the closed position 20a, and may initially provide a tamper proof seal. That is, the opening mechanism 24 enables the secondary dispenser 20 to move between the closed position 20b and the open position 20a. Further examples of opening mechanisms include fasteners, clasps, and other mechanism that attach, seal, or lock the secondary dispenser 20 to maintain a tight seal when in the closed position 20a while enabling the secondary dispenser to move to the open position 20b.

In this example embodiment, both the primary dispenser 18 and the secondary dispenser 20 are located on the first end 12. However, the primary dispenser 18 and the secondary dispenser 20 may be located on different ends. Further, in this example embodiment, the secondary dispenser 20 extends from a position on the first end 12 on the left side of the primary dispenser 18 to a portion of siding adjacent to the first end on the right side of the primary dispenser 18 such that the secondary dispenser 20 encloses the primary dispenser 18. However, in other embodiments the secondary dispenser 20 may not enclose the primary dispenser 18, and instead may be to the side of primary dispenser 18. In this example embodiment, the second end 14 is flat and adapted to support the container on a horizontal surface, but in other embodiments the first end 12 may be flat and adapted to support the container 10 on a horizontal surface, or the siding 16 may be configured to support the container 10 on a surface.

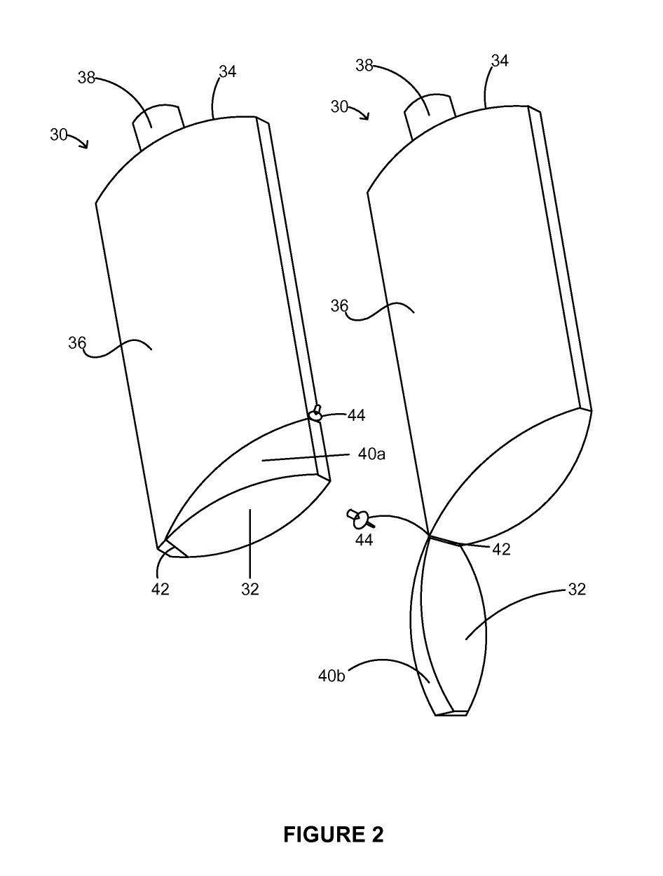

Referring now to FIG. 2, which illustrates perspective views of another container 30 for dispensing liquid in accordance with other embodiments described herein.

The container 30 for dispensing liquid has a first end 32, a second end 34, and siding 36 defining a hollow container body. The siding 36 extends around the perimeter of the first end 32 and second end 34 and is sealingly connected to the first end 32 and second end 34 in order to contain liquid when it is inserted into the container 30.

The container 30 has a primary dispenser 38 and in this example embodiment, the primary dispenser 38 is located in approximately the middle of the second end 34.

The container 30 also has a secondary dispenser 40. The secondary dispenser 40 has a closed position 40a for sealing the liquid within the container 30 and an open position 40b for dispensing the liquid from the container 30. The secondary dispenser 40 is defined by a portion of the first end 32 and a portion of siding 36 adjacent to the first end 32. As shown, the secondary dispenser 40 is defined by a large part of the first end 32 and a portion of the siding 36 that abuts the first end 32. In other embodiments, the secondary dispenser 40 may be defined by a smaller part of the first end 32 and a larger portion of the siding 36 that abuts the first end 32, or a larger or smaller part of both.

The secondary dispenser 40 comprises a hinge 42 and an opening mechanism 44. In this example embodiment, the hinge 22 is located on the first end 32 and the opening mechanism 24 is located on siding 36 adjacent to the first end 16. The hinge 42 may be an integral hinge and the opening mechanism 24 may be a pull tab 44 that initially sealingly locks onto the siding 16 and when the pull tab 44 is pulled it breaks a seal to enable the secondary dispenser 40 to move from the closed position 40a to the open position 40b. In some embodiments the opening mechanism 24 may be resealable and in other embodiments the opening mechanism 24 may not be resealable.

In this example embodiment, the primary dispenser 18 is located on the second end 34 and the secondary dispenser 40 is located on the first end 32. In this example embodiment, the first end 32 is flat and adapted to support the container 30 on a horizontal surface. As the container 30 is supported by the first end 32 and the secondary dispenser 40 is also located on a portion of the first end 32 then liquid in the container 30 will gravitate towards the first end 32 and it may be easier to access liquid collected at the first end 32 using the secondary dispenser 40. This may especially be the case when there is only a small amount of liquid left in the container 30. In addition, the primary dispenser 38 and the secondary dispenser 32 may have different shapes to provide alternative ways to access the liquid. In this example embodiment, the primary dispenser 38 may be smaller in size with a more directed opening making it easier to access small amounts of the liquid within the container 30, especially when there is still a substantial amount of liquid left in the container 30. However, as the liquid empties with use it may be desirable to access the remaining amount of liquid that has collected on the first end 32 due to gravity using the secondary dispenser 40. In addition, the larger and different size of the secondary dispenser 40 may provide alternative options to access the liquid such as by using an instrument or hand, for example.

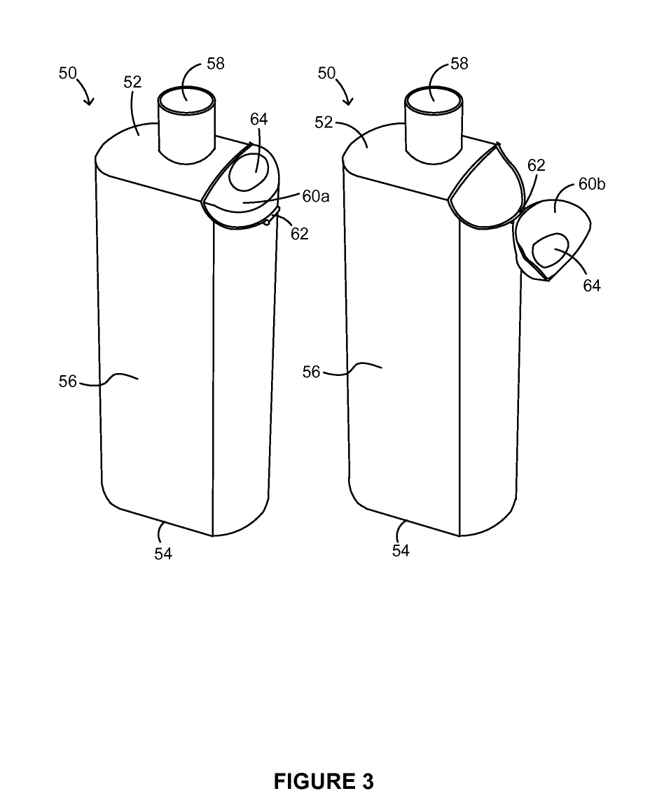

Referring now to FIG. 3, which illustrates perspective views of a container 50 for dispensing liquid in accordance with other embodiments described herein.

The container 50 for dispensing liquid has a first end 52, a second end 54, and siding 56 defining a hollow container body. The siding 56 extends around the perimeter of the first end 52 and second end 54 and is sealingly connected to the first end 52 and second end 54 in order to contain liquid when it is inserted into the container 50.

The container 50 has a primary dispenser 58 for dispensing the liquid from the container 50. In this example embodiment, the primary dispenser 58 is located in approximately the middle of the first end 52.

The container 50 has a secondary dispenser 60 for dispensing the liquid from the container 50. The secondary dispenser 60 may be used when the container is almost empty of liquid when it is difficult to dispense the liquid using the primary dispenser 58. The secondary dispenser 60 may also have a different shape than the primary dispenser 58 to provide an alternative way to access the liquid, such as for example using an instrument that cannot fit into the primary dispenser 58.

The secondary dispenser 60 has a closed position 60a for sealing the liquid within the container 50 and an open position 60b for dispensing the liquid from the container 50. The secondary dispenser 60 is defined by a portion of the first end 52 and a portion of siding 56 adjacent to the first end 52. As shown, the secondary dispenser 60 is defined by a side portion of the first end 52 and a top portion of the siding 56 that abuts the first end 52. In other embodiments, the secondary dispenser 60 may be defined by larger or smaller portions of the first end 52 and larger or smaller portions of the siding 56 that abuts the first end 52. The secondary dispenser 60 comprises a hinge 62 and an opening mechanism 64. The opening mechanism 64 may be used to change the secondary dispenser 60 from the closed position 60a to the open position 60b, and vice versa. In this example embodiment, the hinge 62 is located on the siding 56 adjacent to the first end 52 and the opening mechanism 64 is located on the first end 64. The hinge 62 may be an integral hinge and the opening mechanism 64 may be a thumb notch adapted to receive the thumb of a user. The opening mechanism 64 sealingly locks onto the first end 52 and siding 56 by an integral bead rim formed around the perimeter of the secondary dispenser 60 on the container 50 such that the rim of the secondary dispenser 60 forms a snap seal with the integral bead on the container 50. In this example embodiment, the opening mechanism 64 is configured so that it can reseal the secondary dispenser 60 for multiple movements from the closed position 60a to the open position 60b and from the open position 60b to the closed position 60a. In some embodiments, the opening mechanism 64 may not have a hinge and may use a different mechanism to move between the open position 60b and the closed position 60a. For example, the opening mechanism 64 may use a twist cap or may pop off and on the container 50.

In this example embodiment, both the primary dispenser 58 and the secondary dispenser 60 are located on the first end 52. Further, in this example embodiment, the secondary dispenser 60 extends from a position on the first end 52 on one side of the primary dispenser 58 to a portion of siding 56 adjacent to the first end 52 on the same one side of the primary dispenser 58 such that the secondary dispenser 60 is situated to the one side of the primary dispenser 58. In this example embodiment, the second end 54 is flat and adapted to support the container 50 on a horizontal surface.

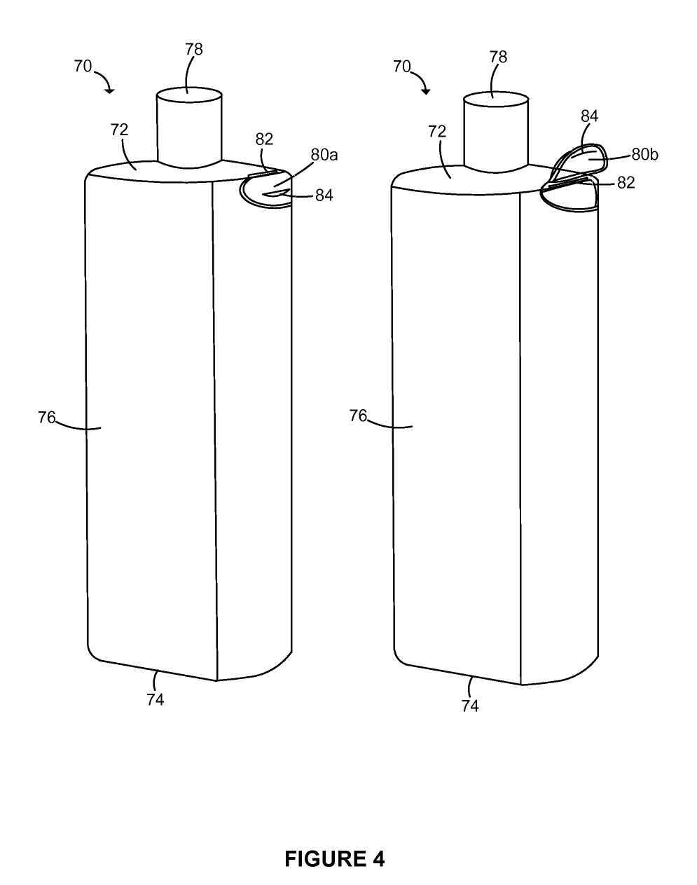

Referring now to FIG. 4, which illustrates perspective views of a container 70 for dispensing liquid in accordance with other embodiments described herein.

The container 70 for dispensing liquid has a first end 72, a second end 74, and siding 76 defining a hollow container body. The siding 76 extends around the perimeter of the first end 72 and second end 74 and is sealingly connected to the first end 72 and second end 74 in order to contain liquid when it is inserted into the container 70.

The container 70 has a primary dispenser 78 for dispensing the liquid from the container 70. In this example embodiment, the primary dispenser 78 is located in approximately the middle of the first end 72.

The container 70 has a secondary dispenser 80 for dispensing the liquid from the container 70. The secondary dispenser 80 may be used when the container is almost empty of liquid when it is difficult to dispense the liquid using the primary dispenser 68. The secondary dispenser 80 may have a different shape and location than the primary dispenser 78 to provide an alternative way to access the liquid, such as for example using an instrument that cannot fit into the primary dispenser 78. The secondary dispenser 80 may be smaller and situated on the corner of the container 70 to direct the liquid.

The secondary dispenser 80 has a closed position 80a for sealing the liquid within the container and an open position 80b for dispensing the liquid from the container. The secondary dispenser 80 is defined by a portion of the first end 72 and a portion of siding 76 adjacent to the first end 72. As shown, the secondary dispenser 80 is defined by a side portion of the first end 72 and a top portion of the siding 76 that abuts the first end 82. The secondary dispenser 80 may comprise a hinge 82 and an opening mechanism 84. The opening mechanism 84 may be used to change the secondary dispenser 80 from the closed position 80a to the open position 80b, and vice versa. In this example embodiment, the hinge 82 is located on the first end 74 and the opening mechanism 84 is located on the siding 76 adjacent to the first end 72. The hinge 82 may be an integral hinge and the opening mechanism 84 may be a thumb notch adapted to receive the thumb of a user. The opening mechanism 84 may sealingly lock onto the first end 72 and siding 76 by an integral bead rim formed around the perimeter of the secondary dispenser 80 on the container 70 such that the rim of the secondary dispenser 80 forms a snap seal with the integral bead on the container 70. In this example embodiment, the opening mechanism 84 is configured so that it can reseal the secondary dispenser 80 for multiple movements from the closed position 80a to the open position 80b and from the open position 80b to the closed position 80a. In other embodiments, the opening mechanism 84 may not be resealable.

In this example embodiment, both the primary dispenser 78 and the secondary dispenser 80 are located on the first end 72. Further, in this example embodiment, the secondary dispenser 80 extends from a position on the first end 72 on one side of the primary dispenser 78 to a portion of siding 76 adjacent to the first end 72 on the same one side of the primary dispenser 78 such that the secondary dispenser 80 is situated to the one side of the primary dispenser 78. In this example embodiment, the second end 74 is flat and adapted to support the container 70 on a horizontal surface.

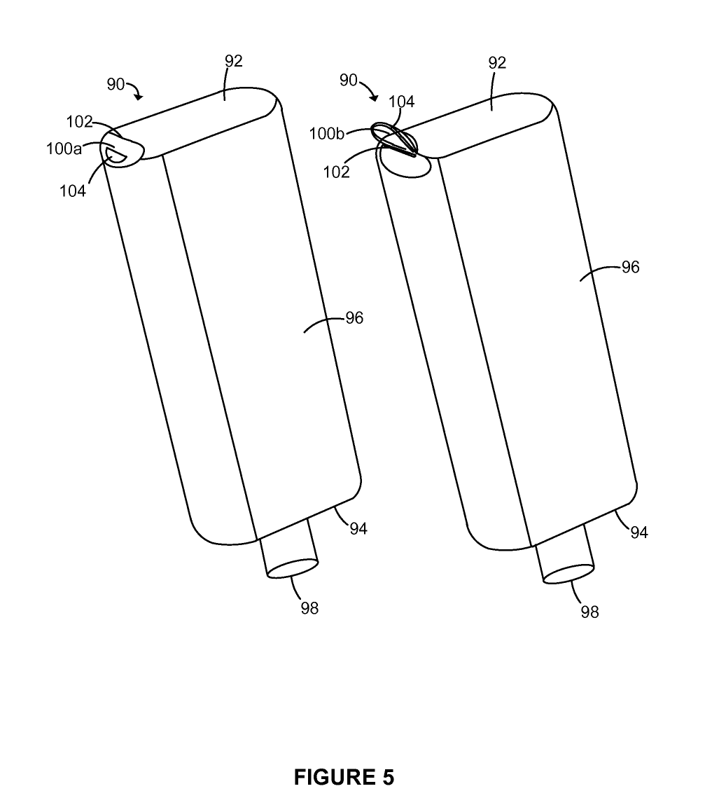

Referring now to FIG. 5, which illustrates perspective views of a container 90 for dispensing liquid in accordance with other embodiments described herein.

The container 90 for dispensing liquid has a first end 92, a second end 94, and siding 96 defining a hollow container body. The siding 96 extends around the perimeter of the first end 92 and second end 94 and is sealingly connected to the first end 92 and second end 94 in order to contain liquid when it is inserted into the container 90.

The container 90 has a primary dispenser 98 for dispensing the liquid from the container 90. In this example embodiment, the primary dispenser 78 is located in approximately the middle of the second end 94.

The container 90 has a secondary dispenser 100 for dispensing the liquid from the container 90. The secondary dispenser 100 may be used when the container is almost empty of liquid when it is difficult to dispense the liquid using the primary dispenser 98. The secondary dispenser 100 may have a different shape and location than the primary dispenser 98 to provide an alternative way to access the liquid. In this example embodiment, the first end 92 is flat and adapted to support the container 30 on a horizontal surface. As the container 90 is supported by the first end 92 and the secondary dispenser 100 is also located on a portion of the first end 92 then liquid in the container 90 may gravitate towards the first end 92 and it may be easier to access liquid collected at the first end 92 using the secondary dispenser 40. This may especially be the case when there is only a small amount of liquid left in the container 90.

The secondary dispenser 100 has a closed position 100a for sealing the liquid within the container and an open position 100b for dispensing the liquid from the container. The secondary dispenser 100 is defined by a portion of the first end 92 and a portion of siding 96 adjacent to the first end 92. The secondary dispenser 100 may also be defined by a larger or smaller portion of the first end 92 and a larger or smaller portion of siding 96 adjacent to the first end 92. As shown, the secondary dispenser 100 is defined by a side portion of the first end 92 and a portion of the siding 96 that abuts the first end 92. The secondary dispenser 100 comprises a hinge 102 and an opening mechanism 104. The opening mechanism 104 may be used to change the secondary dispenser 100 from the closed position 100a to the open position 100b, and vice versa. In this example embodiment, the hinge 102 is located on the first end 94 and the opening mechanism 104 is located on the siding 96 adjacent to the first end 92. The hinge 102 may be an integral hinge and the opening mechanism 104 may be a thumb notch or other notch adapted to receive the thumb or portion of a finger of a user. The opening mechanism 104 sealingly locks onto the first end 92 and siding 96 by an integral bead rim formed around the perimeter of the secondary dispenser 100 on the container 90 such that the rim of the secondary dispenser 100 forms a snap seal with the integral bead on the container 90. In this example embodiment, the opening mechanism 104 is configured so that it can reseal the secondary dispenser 100 for multiple movements from the closed position 100a to the open position 100b and from the open position 100b to the closed position 100a.

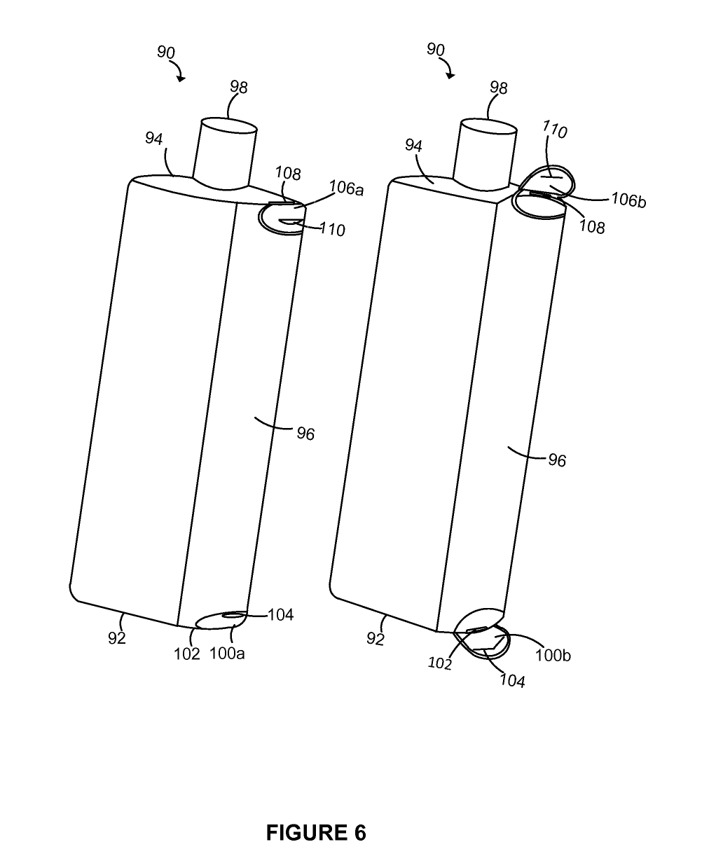

Referring now to FIG. 6, which illustrates perspective views of an alternative configuration of the container 90 of FIG. 5 in accordance with other embodiments described herein. The container 90 may further comprise a tertiary dispenser 106 for dispensing the liquid from the container. In accordance with some embodiments, the tertiary dispenser 108 is formed by a portion of the second end 94 and a portion of siding 96 adjacent to the second end 94. The tertiary dispenser 108 may also formed by a portion of the first end 92 and a portion of siding 96 adjacent to the first end 92, on the opposite corner of the secondary dispenser 100, for example The tertiary dispenser 108 comprises a hinge and an opening mechanism to move the tertiary dispenser from a closed position 106a to an open position 106b. In this example, the hinge 102 is located on the second end 94 and the opening mechanism 104 is located on a portion of the siding 96 adjacent to the second end 94, but they may also be the other way around. In some embodiments there may also be a fourth dispenser (not shown) or even additional dispensers located on the first and 92 on the opposite corner of the secondary dispenser 100 or on the second and 94 on the opposite corner of the tertiary dispenser 108. In addition the secondary dispenser 100 may be shaped like the secondary dispenser 40 of FIG. 2 such that it covers a large portion of the first end. The tertiary dispenser 108 may have an alternative configuration such as the shape of the secondary dispenser 20 of FIG. 1. There may be additional dispensers as well in other embodiments. Further, the secondary dispenser 100 and tertiary dispenser 106 may be different shapes and sizes to provide alternative access to the liquid.

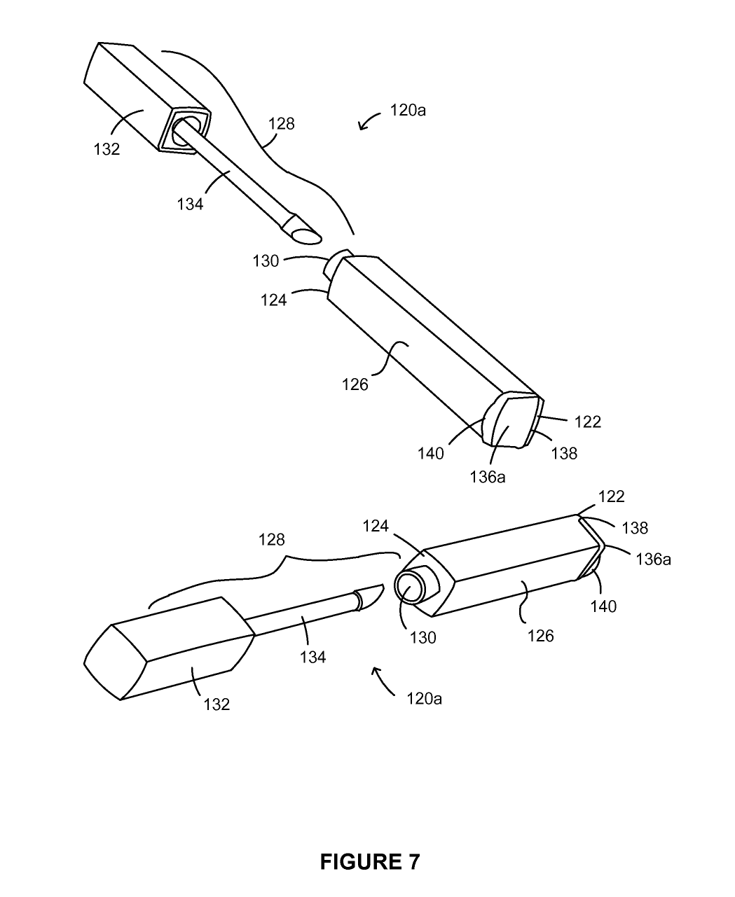

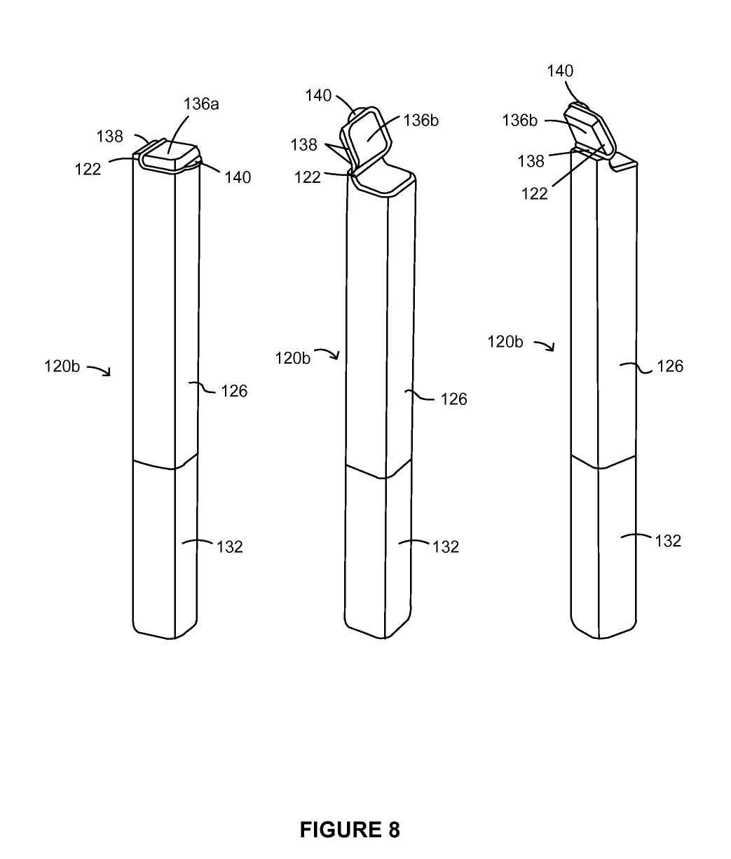

Referring now to FIGS. 7 and 8, which illustrate perspective views of a container 120 for dispensing liquid in accordance with other embodiments described herein. In this example embodiment the container 120 may be used to contain liquid such as a paste, gloss or cream, an example being cosmetics such as concealer or lip gloss. Although the container 120 is illustrated as having a three dimensional rectangular shape, the container 120 may be a different shape such as a cylinder, prism, sphere, tube, cube, pyramid, cone and so on, or a combination thereof.

The container 120 for dispensing liquid has a first end 122, a second end 124, and siding 126 defining a hollow container body. The siding 126 extends around the perimeter of the first end 122 and second end 124 and is sealingly connected to the first end 122 and second end 124 in order to contain liquid when it is inserted into the container 120.

The container 120 has a primary dispenser 128, which in this example embodiment, is located on the second end 124. The primary dispenser 128 comprises an opening 130 in the second end 124, a cap 132 configured to sealingly connect with the opening 130 and an applicator wand 134 connected to the cap 132 and shaped to be inserted within the hollow container body to access the liquid therein. The container 120a has an open position when the primary dispenser 128 is pulled out (FIG. 7) and the container 120b has a closed position when the primary dispenser 128 is inserted therein (FIG. 8).

The container 120 has a secondary dispenser 136 for dispensing the liquid from the container 120. The secondary dispenser 136 may be used when the container is almost empty of liquid when it is difficult to dispense the liquid using the opening 130 of the primary dispenser 128. The secondary dispenser 136 provides an alternative way to access the liquid, especially when there is only a small amount of liquid left in the container 120. The secondary dispenser 136 may be shaped such that the wand 134 of the primary dispenser 128 can be inserted therein to access the liquid within the container.

The secondary dispenser 136 has a closed position 136a for sealing the liquid within the container 120 and an open position 136b for dispensing the liquid from the container 120. The secondary dispenser 136 is defined by a portion of the first end 122 and a portion of siding 126 adjacent to the first end 122. As shown, in this example the secondary dispenser 136 is defined by a larger portion of the first end 122 and a portion of the siding 126 that abuts the first end 122. In other examples the secondary dispenser 136 may be defined by a smaller portion of the first end 122 and a larger portion of the siding 126 that abuts the first end 122.

The secondary dispenser 136 comprises a hinge 138 and an opening mechanism 140. The opening mechanism 140 may be used to change the secondary dispenser 136 from the closed position 136a to the open position 136b, and vice versa. In this example embodiment, the hinge 138 is located on the first end 122 and the opening mechanism 140 is located on a portion of the siding 126 adjacent to the first end 122. The hinge 138 may be an integral hinge and the opening mechanism 140 may be a clasp and also include a mechanism that sealingly locks onto the first end 122 and siding 126 by an integral bead rim formed around the perimeter of the secondary dispenser 136 on the container 120 such that the rim of the secondary dispenser 136 forms a snap seal with the integral bead on the container 120. In this example embodiment, the opening mechanism 140 is configured so that it can reseal the secondary dispenser 136 for multiple movements from the closed position 136a to the open position 136b and from the open position 136b to the closed position 136a. The hinge may be a living hinge that is integrally molded onto the container.

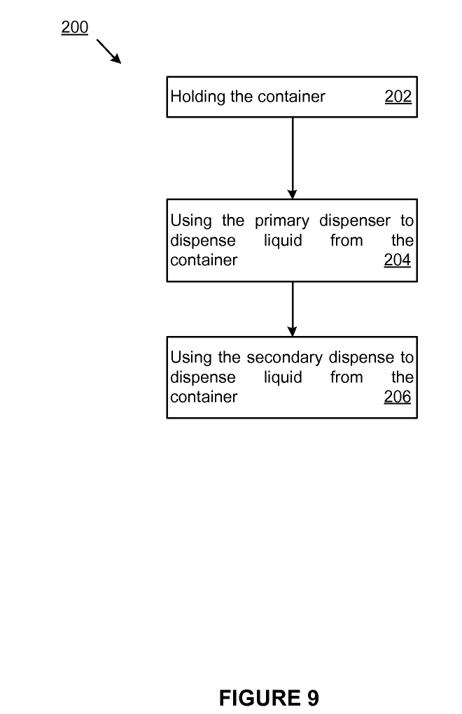

Referring now to FIG. 9, which illustrates a flow chart diagram of a method 200 dispensing liquid in a container 10, 30, 50, 70, 90, 120 in accordance with other embodiments described herein.

At step 202, the method 200 involves holding a container 10, 30, 50, 70, 90, 120 as described herein.

At step 204, the method 200 involves using the primary dispenser to dispense the liquid from the container 10, 30, 50, 70, 90, 120.

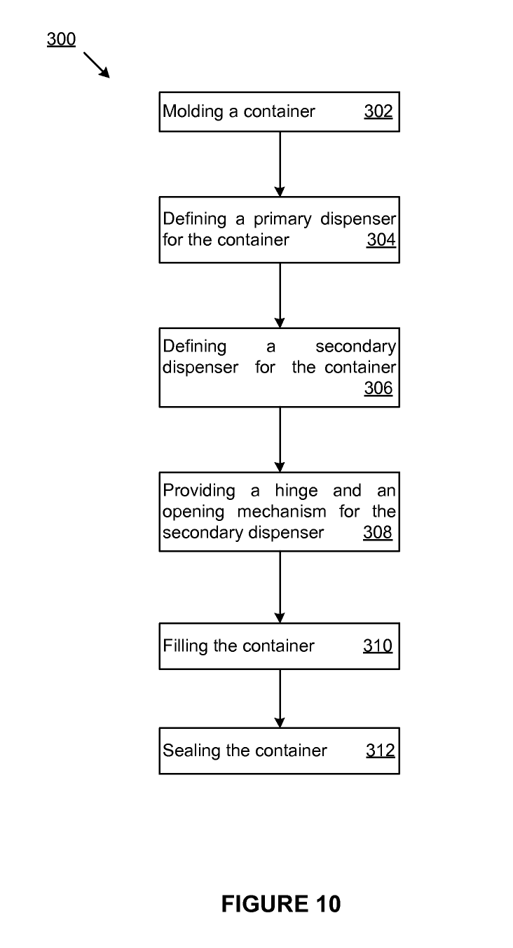

At step 206, the method 200 involves using the secondary dispenser to dispense the liquid from the container. The secondary dispenser may have a different location or shape than the primary dispenser to provide an alternative mechanism for dispensing liquid in the container. For example the secondary dispenser may be used when there is little liquid left in the container such that it is difficult to dispense liquid using the primary dispenser. As another example the secondary dispenser may have an alternative shape such that instrument may be inserted therein in order to dispense liquid. Referring now to FIG. 10, which illustrates a flow chart diagram of a method 300 of making a container 10, 30, 50, 70, 90, 120 for dispensing liquids in accordance with other embodiments described herein.

At step 302, the method 300 involves molding a container 10, 30, 50, 70, 90, 120 comprising a first end, a second end, and siding defining a hollow container body such that the siding is sealingly connected the to the first end and second end for containing the liquid within the container. The container may be molded using a variety of ways such as extrusion blow molding, injection molding, stretch blow molding, compression molding call, injection blow molding, for example. The components of the container may be using different mechanisms or the same mechanisms. The components may be joined together by using various joining mechanisms such as welding and gluing, for example

At step 304, the method 300 involves defining a primary dispenser for dispensing the fluid from the container 10, 30, 50, 70, 90, 120.

At step 306, the method 300 involves defining a secondary dispenser as described herein that has an open position for dispensing the fluid from the container and a closed position for sealing the fluid within the container. As described herein, the secondary dispenser is defined by a portion of the first end and a portion of siding adjacent to the first end.

At step 308, the method 300 involves providing a hinge and an opening mechanism for the secondary dispenser. As described herein, the hinge is located on one of the first end and the siding adjacent to the first end and wherein the opening mechanism is located on the other of the first end and the siding adjacent to the first end.

Optionally, at step 310 the method 300 involves filling the container 10, 30, 50, 70, 90, 120 with liquid, and step 312 sealing the container.

In accordance with other embodiments, there is provided a method 300 of filling a container 10, 30, 50, 70, 90, 120 with liquid. The container 10, 30, 50, 70, 90, 120 may be manufactured separately and may have an opening for filling the container 10, 30, 50, 70, 90, 120 with liquid. The empty container 10, 30, 50, 70, 90, 120 with opening may be sold or otherwise provided to another party or location that fills the container 10, 30, 50, 70, 90, 120 with liquid.

The method involves providing liquid into an opening a container 10, 30, 50, 70, 90, 120 comprising a first end, a second end, and siding defining a hollow container body such that the siding is sealingly connected the to the first end and second end for containing the liquid within the container. The container may be molded using a variety of ways such as extrusion blow molding, injection molding, stretch blow molding, compression molding call, injection blow molding, for example. The components of the container may be using different mechanisms or the same mechanisms. The components may be joined together by using various joining mechanisms such as welding and gluing, for example.

The method further involves filling the container 10, 30, 50, 70, 90, 120 with liquid, and step 312 sealing the container.

These are merely example embodiments and there may be other variations and configurations. For example, the container may be a tube such as the toothpaste tube and the primary dispenser may be on a second end that has a circular face and the secondary dispenser may be on a first end which is a flattened portion of the end of the tube. The siding may make up the tube body and may be configured to support the tube on a flat surface. The secondary dispenser may extend from a portion of the first end to a portion of siding adjacent to the first end and may be configured to be torn off by the user in order to access the contents of the container when for example primary dispenser is inadequate.

In addition, the primary dispenser in the secondary dispenser may be initially tamperproof. For example there may be pull tab mechanism to initially unlock the primary dispenser or the secondary dispenser, such as a plastic strip or seal. As another example, the entire container may be shrink wrapped or covered in a shrink sleeve made out of a thin substrate that may be removed prior to use. Other tamperproof mechanisms may also be implemented. In addition, the secondary dispenser may be sealingly connected to the container in a liquid tight manner so that the liquid does not leak out of the secondary dispenser when it is in a closed position.

The container and components thereof may be constructed using a flexible substrate to facilitate dispensing a liquid using the primary or secondary dispensers, such as for example thermoplastic materials, polycarbonates, polyolefins, polyesters, resins, and pliable thin laminated metallic materials such as aluminum laminates as used for toothpaste tubes. The components may be made out of the same material or different materials. The dispensers may be implemented using various configurations such as a cap, snap lid, spray nozzle, some slide, pump mechanism, and so on. The container may be implemented using a variety of materials suitable for containing the liquid therein and may be in a variety of shapes such as rectangular, circular, square, cylindrical, tapered, or combination thereof, for example. The first end or the second end or both may be adapted to support the container on a horizontal surface. The primary and secondary dispensers may protrude out from one of the ends or may be recessed within one of the ends. The secondary dispenser may be larger or smaller than the primary dispenser. For example if the secondary dispenser is larger than the primary dispenser and is resealable it may be used to refill the container with liquid in a way that is more convenient than using the primary dispenser. As also described herein the secondary dispenser may facilitate the dispensing a liquid win the primary dispenser is not adequate, or as an alternative thereto, and may be positioned in the location where the liquid tends to gravitate. In addition the secondary dispenser may facilitate the use of an instrument in order to dispense liquid from the container.

Embodiments have been described here by way of example only. Various modification and variations may be made to these exemplary embodiments without departing from the spirit and scope of the invention, which is limited only by the appended claims.

We claim:

1. A container for dispensing liquid comprising:
a first end;
a second end;
siding defining a hollow container body, wherein the siding is sealingly connected to the first end and second end for containing the liquid within the container;
a primary dispenser for dispensing the liquid from the container;
a secondary dispenser having a closed position for sealing the liquid within the container and an open position for dispensing the liquid from the container, wherein the secondary dispenser is defined by a portion of the first end and a portion of siding adjacent to the first end, wherein the secondary dispenser comprises a hinge and an opening mechanism, wherein the hinge is located on one of the first end and the siding adjacent to the first end and wherein the opening mechanism is located on the other of the first end and the siding adjacent to the first end.

2. The container of claim 1, wherein the primary dispenser is located on the first end.

3. The container of claim 2, wherein the secondary dispenser extends from a position on the first end on one side of the primary dispenser to a portion of siding adjacent to the first end on the other side of the primary dispenser such that the secondary dispenser encloses the primary dispenser.

4. The container of claim 1, wherein the secondary dispenser extends from a position on the first end on one side of the primary dispenser to a portion of siding adjacent to the first end on the same one side of the primary dispenser such that the secondary dispenser is situated on the one side of the primary dispenser.

5. The container of claim 1, wherein the second end is adapted to support the container on a horizontal surface.

6. The container of claim 1, wherein the first end is adapted to support the container on a horizontal surface.

7. The container of claim 1, wherein the primary dispenser is located on the second end.

8. The container of claim 1, wherein the opening mechanism is a resealable clasp mechanism.

9. The container of claim 1, wherein the opening mechanism is a pull tab mechanism.

10. The container of claim 1, wherein the opening mechanism is a thumb notch mechanism.

11. The container of claim 1, further comprising:
a tertiary dispenser for dispensing the liquid from the container, wherein the tertiary dispenser is formed by a portion of the second end and a portion of siding adjacent to the second end, wherein the tertiary dispenser comprises a hinge and an opening mechanism, wherein the hinge is located on one of the second end and the siding adjacent to the second end and wherein the opening mechanism is located on the other of the second end and the adjacent siding.

12. The container of claim 1, wherein the hinge is an integral hinge.

13. The container of claim 1, wherein the primary dispenser comprises an opening on the second end, a cap configured to sealingly connect to the opening and an applicator wand connected to the cap and shaped to be inserted within the hollow container body.

14. A method of providing liquid in a container having an opening comprising the steps:
providing liquid in the opening of the container, wherein the container comprises:
a first end;
a second end;
siding defining a hollow container body, wherein the siding is sealingly connected to the first end and second end for containing the liquid within the container;
a primary dispenser for dispensing the liquid from the container;
a secondary dispenser having an open position for dispensing the liquid from the container and a closed position for sealing the liquid within the container, wherein the secondary dispenser is defined by a portion of the first end and a portion of siding adjacent to the first end, wherein the secondary dispenser comprises a hinge and an opening mechanism, wherein the hinge is located on one of the first end and the siding adjacent to the first end and wherein the opening mechanism is located on the other of the first end and the adjacent siding; and
sealing the opening of the container.

15. The method of claim 14, wherein the primary dispenser is located on the first end and the secondary dispenser extends from a position on the first end on one side of the primary dispenser to a portion of siding adjacent to the first end on the other side of the primary dispenser such that the secondary dispenser encloses the primary dispenser.

16. The method of claim 14, wherein the primary dispenser is located on the first end and the secondary dispenser extends from a position on the first end on one side of the primary dispenser to a portion of siding adjacent to the first end on the same one side of the primary dispenser such that the secondary dispenser is situated on the one side of the primary dispenser.

17. A method of making a container for dispensing liquids comprising the steps:
molding a container comprising a first end, a second end, and siding defining a hollow container body such that the siding is sealingly connected the to the first end and second end for containing the liquid within the container;
defining a primary dispenser for dispensing the liquid from the container;
defining a secondary dispenser having an open position for dispensing the liquid from the container and a closed position for sealing the liquid within the container, wherein the secondary dispenser is defined by a portion of the first end and a portion of siding adjacent to the first end;
providing a hinge and an opening mechanism for the secondary dispenser, wherein the hinge is located on one of the first end and the siding adjacent to the first end and wherein the opening mechanism is located on the other of the first end and the siding adjacent to the first end.

18. The method of claim 17, further comprising:
filling the container with liquid; and
sealing the container.

19. The method of claim 17, wherein the primary dispenser is located on the first end and the secondary dispenser extends from a position on the first end on one side of the primary dispenser to a portion of siding adjacent to the first end on the other side of the primary dispenser such that the secondary dispenser encloses the primary dispenser.

20. The method of claim 17, wherein the primary dispenser is located on the first end and the secondary dispenser extends from a position on the first end on one side of the primary dispenser to a portion of siding adjacent to the first end on the same one side of the primary dispenser such that the secondary dispenser is situated on the one side of the primary dispenser.
